(19) United States
(12) Patent Application Publication
(10) Pub. No.: US 2010/0182766 A1
(43) Pub. Date: Jul. 22, 2010

(54) ILLUMINATION DEVICE WITH FLEXIBLE LIGHT TRANSMISSIVE FILM

(75) Inventor: Chih-Ming LAI, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/622,708

(22) Filed: Nov. 20, 2009

(30) Foreign Application Priority Data
Jan. 16, 2009 (CN) 200910300249.3

(51) Int. Cl. F21V 9/16; F21V 3/00

(52) U.S. Cl. 362/84; 362/277

(57) ABSTRACT

An exemplary illumination device includes a light source, a flexible light transmissive film and a driving module. The light source is for emitting light. The flexible light transmissive film has a substantially rectangular shape. The flexible light transmissive film is divided into a plurality of optical wavelength converting regions successively arranged along a longitudinal direction of the rectangular shape. The driving module is mechanically connected to at least one end of the light transmissive film and configured for winding up the light transmissive film, thereby driving the light transmissive film to travel along the longitudinal direction.

### BACKGROUND

1. Technical Field

The present disclosure generally relates to illumination devices, particularly, to an illumination device using light emitting diodes as a light source.

2. Description of Related Art

Light emitting diodes (LEDs) have recently been used extensively as light sources for illumination devices due to their high luminous efficiency, low power consumption and long life span. In some LED illumination devices, to satisfy certain illumination requirements, light mixing is employed. That is, light having different colors or wavelengths is emitted from different light emitting diodes, and such light is mixed to form light of a desired color or wavelength. However, once the different light emitting diodes of the illumination device are encapsulated together to emit a desired color or wavelength, further change in the color or wavelength of the illumination device would be difficult and inconvenient.

Therefore, what is needed is an illumination device that overcomes the described limitations.

### BRIEF DESCRIPTION OF THE DRAWINGS

Many aspects of the disclosed illumination device can be better understood with reference to the following drawings. The components in the drawings are not necessarily drawn to scale, the emphasis instead being placed upon clearly illustrating the principles of the present illumination device.

FIG. 1 is a schematic view of an illumination device, according to an exemplary embodiment.

FIG. 2 is a chromaticity diagram of the illumination device of FIG. 1 according to an exemplary embodiment.

FIG. 3 is a chromaticity diagram of the illumination device of FIG. 1 according to another exemplary embodiment.

### DETAILED DESCRIPTION

Reference will now be made to the drawing to describe exemplary embodiments of the illumination device, in detail.

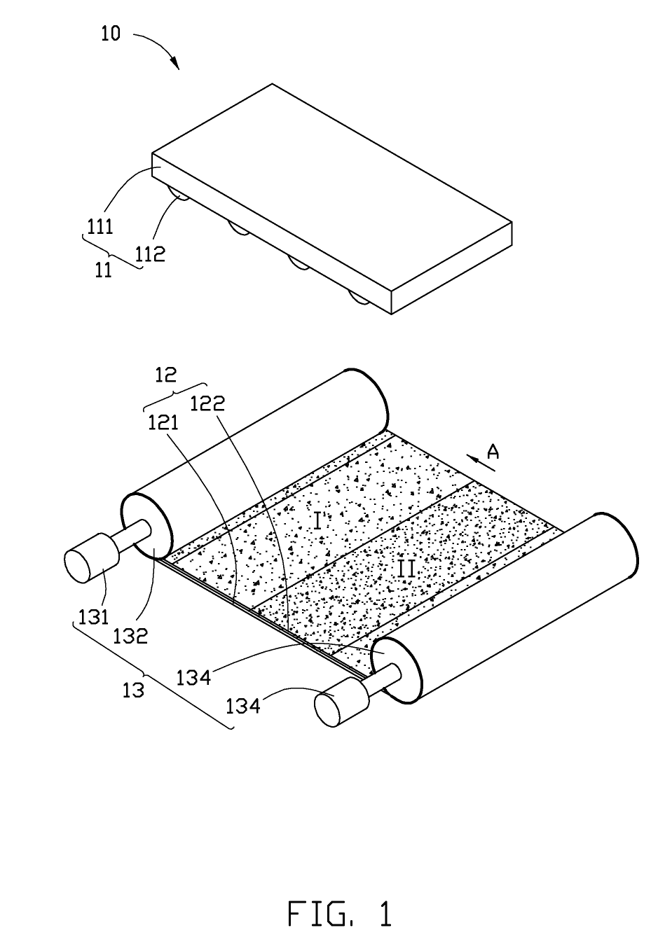

Referring to FIG. 1, an illumination device 10, according to an exemplary embodiment, includes a light source 11, a light transmissive film 12 and a driving module 13.

The light source 11 includes a substrate 111, and a plurality of light emitting diodes 112 arranged on the substrate 111. The light source 11 can be used for emitting light having a wavelength ranging from green light to ultraviolet light. In an exemplary embodiment, the light source 11 emits blue light, and a full width at half maximum of the blue light is no more than 30 nanometers (nm).

The light transmissive film 12 is arranged at a light emitting side of the light source 11. The light transmissive film 12 has a light transmittance of at least 70%. Such a rate of light transmittance may be considered as acceptable optical loss of the light emitted from the light source 11 to the light transmissive film 12.

The light transmissive film 12 is substantially rectangular-shaped and flexible.

The light transmissive film 12 includes a light transmissive substrate 121, and an optical wavelength converting portion 122 formed on the substrate 121. In the exemplary embodiment, the optical wavelength converting portion 122 is formed as an optical wavelength converting film. The substrate 121 can be made of resin, silicone, polyethylene terephthalate, polymethyl methacrylate or polycarbonate. The substrate 121 has a thickness equal to or less than 1000 microns. The optical wavelength converting portion 122 can include phosphor material (“phosphor”), and the phosphor can include any one or more of sulfides, aluminates, oxides, silicates and nitrides. For example, the optical wavelength converting portion 122 can include Ca₂Al₁₂O₁₉:Mn, (Ca,Sr,Ba)Al₂O₄:Eu, CdS, CdTe, Y₃A₁₅O₁₂Ce³⁺(YAG), Tb₃Al₅O₁₂: Ce^{3°}(YAG), BaMgAl₁₀O₁₇: Eu²⁺(Mn²⁺), Ca₂Si₅N₈:Eu²⁺, (Ca,Sr,Ba)S:Eu²⁺, (Mg,Ca,Sr,Ba)₂SiO₄:Eu²⁺, (Mg,Ca,Sr,Ba)₃Si₂O₇:Eu²⁺, Y₂O₂S:Eu³⁺, Ca₈Mg(SiO₄)₄Cl₂:Eu²⁺, (Sr,Ca,Ba)SiₓO_{y}N_{z}:Eu²⁺, (Ca,Mg,Y)SiAlₓO_{y}N_{z}:Eu²⁺, and/or CdSe. In the exemplary embodiment, the optical wavelength converting portion 122 has a thickness equal to or less than 500 microns.

The light transmissive film 12 is divided into a plurality of optical wavelength converting regions, for example including regions I and II as labeled in the drawing. The optical wavelength converting regions are successively arranged along a longitudinal direction of the light transmissive film 12. In the illustrated embodiment, the optical wavelength converting regions are rectangular, and essentially oblong. Each of the optical wavelength converting regions includes a part of the substrate 121 and a corresponding part of the optical wavelength converting portion 122 thereon. In the illustrated embodiment, each optical wavelength converting region has essentially a uniform concentration of the phosphor in the optical wavelength converting portion 122. Each optical wavelength converting region has a concentration of the phosphor in the optical wavelength converting portion 122 different from that of each other optical wavelength converting region. Therefore, light passing through different optical wavelength converting regions is absorbed in varying degrees, and mixed light of the different optical wavelength converting regions has different colors or/and chromas.

Alternatively, the phosphor can be randomly but substantially uniformly mixed in a base material of the substrate 121. In one such example, each of the optical wavelength converting regions has a concentration of phosphor different from that of each other optical wavelength converting region.

The driving module 13 includes a motor 131, a first roller 132 and a second roller 133. The first roller 132 is mechanically connected to the motor 131. The light transmissive film 12 is partly wound around the second roller 133 and has one end portion fixed to the first roller 132. The motor 131 is capable of driving the first roller 132 to rotate. As such, the first roller 132 is capable of pulling the light transmissive film 12 to travel along the longitudinal direction “A” and thereby winding up the light transmissive film 12. While the first roller 132 winds up the light transmissive film 12, each of the optical wavelength converting regions becomes positioned opposite to the light source 11 in succession. Accordingly, each the optical wavelength converting region can be selectively positioned opposite to the light source 11 by controlling the rotation of the first roller 132. The optical wavelength converting region (or regions) opposite to the light source 11 receive light emitted from the light source 11 and convert the wavelength of the light accordingly.

Furthermore, the driving module 13 can also be equipped with another motor 134 mechanically connected to the second roller 133. As such, the motor 134 can drive the second roller 133 to rotate. Thereby, the second roller 133 can pull the light transmissive film 12 to travel along a direction opposite to the direction “A” and wind up the light transmissive film 12.

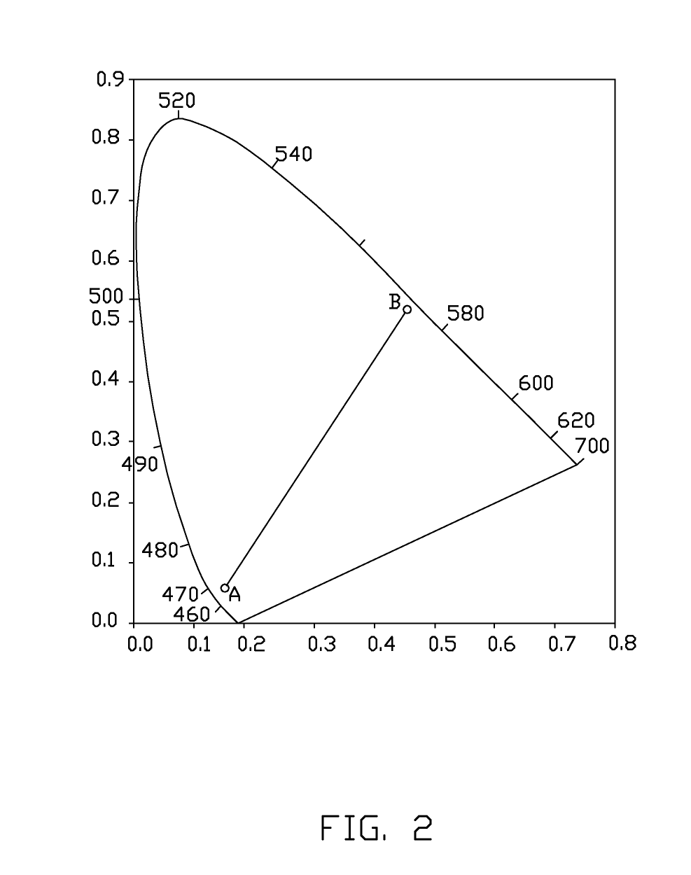

Referring to FIG. 2, a chromaticity diagram is shown. Line segment AB stands for a color space of the illumination device 10. Point A stands for a first light of the light source 11 with a first wavelength. Point B stands for a second light which is formed by the first light being fully absorbed by the phosphor of the optical wavelength converting regions and being converted to be with a second wavelength. As such, if the first light is partly absorbed by the phosphor with different degrees, the mixing light consisted of the first light and the second light will locates at a point on the line segment

AB and between the points A and B.

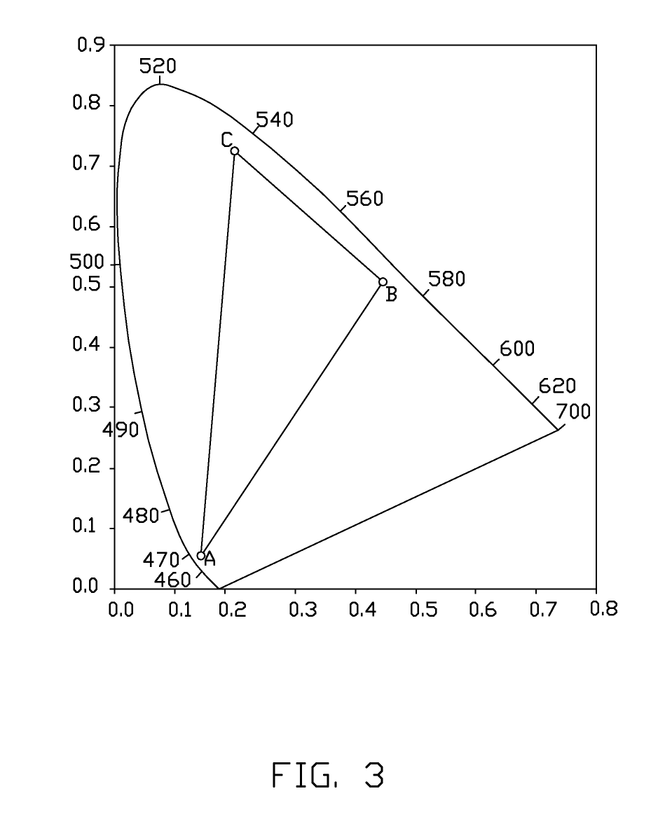

Referring to FIG. 3, another chromaticity diagram is shown. A triangle ABC stands for another color space of the illumination device 10, in case of the optical wavelength converting region has two kinds of phosphor. Point A stands for a first light of the light source 11 with a first wavelength. Point B stands for a second light which is formed by the first light being fully absorbed by a first phosphor of the optical wavelength converting regions and being converted to be with a second wavelength. Point C stands for a third light which is formed by the first light being fully absorbed by a second phosphor of the optical wavelength converting regions and being converted to be with a third wavelength. As such, if the first light is partly absorbed by the first phosphor and/or the second phosphor with different degrees, the mixing light consisted of the first light and/or the second light and/or the third light will locates at a point falling in the triangle ABC.

In summary, the illumination device 10 is equipped with a light transmissive film 12 which has a plurality of optical wavelength converting regions. Each of the optical wavelength converting regions can be selectively positioned opposite to the light source 11 by way of the driving module 13 winding up the light transmissive film 12. Accordingly, the color or/and chroma of the illumination device 10 can be changed according to different requirements by controlling the driving module 13.

Finally, it is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

What is claimed is:

1. An illumination device, comprising:
a light source;
a flexible light transmissive film having a substantially rectangular shape and being divided into a plurality of optical wavelength converting regions successively arranged along a longitudinal direction of the rectangular shape; and
a driving module mechanically connected to an end of the light transmissive film;
wherein the driving module is configured for winding up the light transmissive film such that each of the optical wavelength converting regions can be selectively positioned opposite to the light source and the optical wavelength converting region or regions opposite to the light source receive light emitted from the light source and convert the wavelength of the light.

2. The illumination device according to claim 1, wherein the light transmissive film comprises a light transmissive substrate and an optical wavelength converting film formed on the substrate.

3. The illumination device according to claim 2, wherein the optical wavelength converting film comprises phosphor.

4. The illumination device according to claim 3, wherein the phosphor comprises any one or more items selected from the group consisting of sulfides, aluminates, oxides, silicates and nitrides.

5. The illumination device according to claim 2, wherein the substrate is made of material selected from the group consisting of resin, silicone, polyethylene terephthalate,, polymethyl methacrylate, and polycarbonate.

6. The illumination device according to claim 2, wherein the substrate has a thickness equal to or less than 1000 microns, and the optical wavelength converting film has a thickness equal to or less than 500 microns.

7. The illumination device according to claim 3, wherein the plurality of optical wavelength converting regions are defined according to differences in the optical wavelength converting film, the optical wavelength converting film comprises the same phosphor, and each optical wavelength converting region has a concentration of the phosphor different from a concentration of the phosphor in each of the other optical wavelength converting regions.

8. The illumination device according to claim 4, wherein the plurality of optical wavelength converting regions are defined according to differences in the optical wavelength converting film, the optical wavelength converting film has a substantially uniform concentration of phosphor, and the composition of the phosphor in each of the optical wavelength converting regions is different from the composition of the phosphor in each of the other optical wavelength converting regions.

9. The illumination device according to claim 1, wherein the light source is configured for emitting light having a wavelength in the ranging from the wavelength of green light to the wavelength of ultraviolet light.

10. The illumination device according to claim 9, wherein the light source is configured for emitting blue light.

11. The illumination device according to claim 1, wherein the driving module comprises a motor, a first roller and a second roller, the first roller is mechanically connected to the motor and to the end of the light transmissive film, and the motor is capable of rotating the first roller to wind the light transmissive film around the first roller.

12. The illumination device according to claim 1, wherein the light transmissive film comprises a substrate and phosphor randomly but substantially uniformly mixed in a base material of the substrate.

13. The illumination device according to claim 12, wherein the plurality of optical wavelength converting regions are defined according to differences in the phosphor mixed in the base material of the substrate, and the differences in the phosphor are selected from the group consisting of differences in the concentration of the phosphor and differences in the chemical composition of the phosphor.

14. An illumination device, comprising:
a light source;
a flexible light transmissive film having a plurality of optical wavelength converting regions arranged side by side along a longways axis of the flexible light transmissive film; and
a driving module configured for driving the light transmissive film to travel in either direction along the longways axis, such that each of the optical wavelength converting regions can be selectively located opposite to the light source and thereby convert the wavelength of the light emitted from the light source to a desired wavelength.

15. The illumination device according to claim 14, wherein the light transmissive film comprises a light transmissive substrate, each of the optical wavelength converting regions comprising part of the substrate and an optical wavelength converting substance distributed thereon/therein.

16. The illumination device according to claim 15, wherein the optical wavelength converting substance is a phosphor substance.

17. The illumination device according to claim 15, wherein the substrate has a thickness equal to or less than 1000 microns, the optical wavelength converting film has a thickness equal to or less than 500 microns.

18. The illumination device according to claim 15, wherein the optical wavelength converting substances of the plurality of optical wavelength converting regions are the same, and each optical wavelength converting region comprises a concentration of optical wavelength converting substance different from the others.

19. The illumination device according to claim 15, wherein the optical wavelength converting substances of the plurality of optical wavelength converting regions are different from the others.

20. The illumination device according to claim 14, wherein the driving module comprises a first roller mechanically connected to a first motor, and a second roller mechanically connected to a second motor, one end of the light transmissive film is mechanically connected to the first roller, an opposite end of the light transmissive film is mechanically connected to the second roller, the first motor is capable of rotating the first roller to wind the light transmissive film around the first roller, and the second motor is capable of rotating the second roller to wind the light transmissive film around the second roller.
